(19) United States
(12) Patent Application Publication
(10) Pub. No.: US 2006/0120031 A1
(43) Pub. Date: Jun. 8, 2006

(54) System for improved shock resistance for hard drives

(75) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Osaka (JP)

(21) Appl. No.: 11/005,333

(22) Filed: Dec. 6, 2004

(51) Int. Cl. G06F 1/16

(52) U.S. Cl. 361/685

(57) ABSTRACT

Embodiments of the present invention relate to systems for insulating storage devices from external shocks. A ring made from rubber or some other shock-resistant material is secured to an exterior surface of a hard drive. Alternately, shock-resistant bumpers can be secured to the corners or other sections of the hard drive. The shock resistant ring includes one or more extensions or nipples that can be inserted into holes in the portable device for the purpose of securing the ring and the hard drive to the portable device.

### FIELD OF THE INVENTION

The present invention relates generally to configuring storage devices. The present invention relates more specifically to protecting embedded storage device from impact-related damage.

### BACKGROUND OF THE INVENTION

Over the past ten years, the mass production of storage devices has become both increasingly large in scale and increasingly competitive. The combination of aggressive computer upgrade schedules, increased storage demands driven by media applications, and the opening of foreign markets to computer sales has driven up the size and scale of storage device production. However, at the same time, increased competition has driven down the cost of computer components such as storage devices.

While once used primarily in personal and enterprise computers that were stored in fixed locations and moderate temperatures, hard drives are now appearing in a wide range of portable devices, such as laptop computers, personal data assistants, personal media players, and digital camcorders. As a result the hard drives must be more tolerant of shocks than would be the case for stationary devices. While modifications can be made to the structure of the hard drive itself, such modifications can raise the cost of the devices. A shock absorbing apparatus can be added to the drive, but such mechanisms add considerably to production time and cost. What is needed is a cost and time effective means for insulating hard drives from shock.

### BRIEF DESCRIPTION OF THE DRAWINGS

FIG. 1 is a block diagram illustrating a portable device in which a hard drive resides in accordance with one embodiment of the present invention.

FIG. 2A and FIG. 2B illustrate shock absorbing apparatuses in accordance with one embodiment of the present invention.

FIG. 3 illustrates an overhead view of a portable device in accordance with one embodiment of the present invention.

FIG. 4 is an overhead view of a portable device in accordance with an alternate embodiment of the present invention.

FIG. 5 is a side view illustrating one embodiment of a connection between a hard drive and the portable device in accordance with one embodiment of the present invention.

FIG. 6 is a side view illustrating an alternate embodiment of a connection between a hard drive and the portable device in accordance with one embodiment of the present invention.

FIG. 7 illustrates a flow chart for installing a hard drive.

### Detailed Description

Embodiments of the present invention relate to systems for insulating storage devices from external shocks. A ring made from rubber or some other shock-resistant material is secured to an exterior surface of a hard drive. Alternately, shock-resistant bumpers can be secured to the corners of the hard drive. The shock resistant ring includes one or more extensions or nipples that can be inserted into holes in the portable device for the purpose of securing the ring and the hard drive to the portable device.

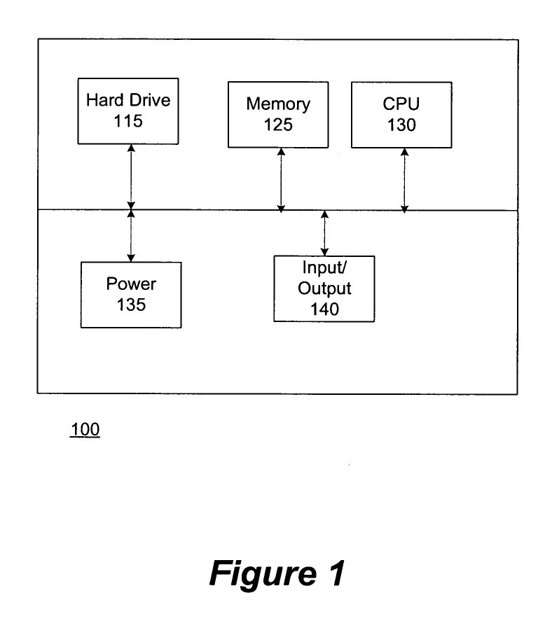

FIG. 1 is a block diagram illustrating a portable device 100. The portable device can be a personal data assistant (PDA), a cellular phone, a personal media player (PMP), a laptop computer, or any other device which might include an embedded hard drive. The portable device includes a power supply 135 that provides power to the portable device 100. The power supply can be an Alternating Current(AC) adapter, a battery, or any other mechanism for providing power to the device. The portable device 100 also includes a memory 125. The memory 125 can be DRAM, SRAM, flash memory, any other memory format, or a combination of multiple memory types. The memory 125 stores the operating instructions for the portable device, as well as data that is temporarily in use.

The portable device also includes an input/output 140. The input/output 140 collectively includes the devices that are used to provide input to and accept output from the portable device 100. The input/output 140 can include one or more Thin Film Transistor (TFT) or Liquid Crystal Display (LCD) displays, speakers, and sound outputs. The input/output 140 also includes devices for providing input to the portable device 100. These input devices can include a keyboard, mouse, touchpad, touchscreen, or any other device so equipped. The portable device also includes a central processing unit (CPU) 130 that performs major calculations/operations for the portable device 100.

Furthermore, the portable device 100 includes a hard drive 115. The hard drive 115 is embedded in the portable device and stores data for use by the portable device 100.

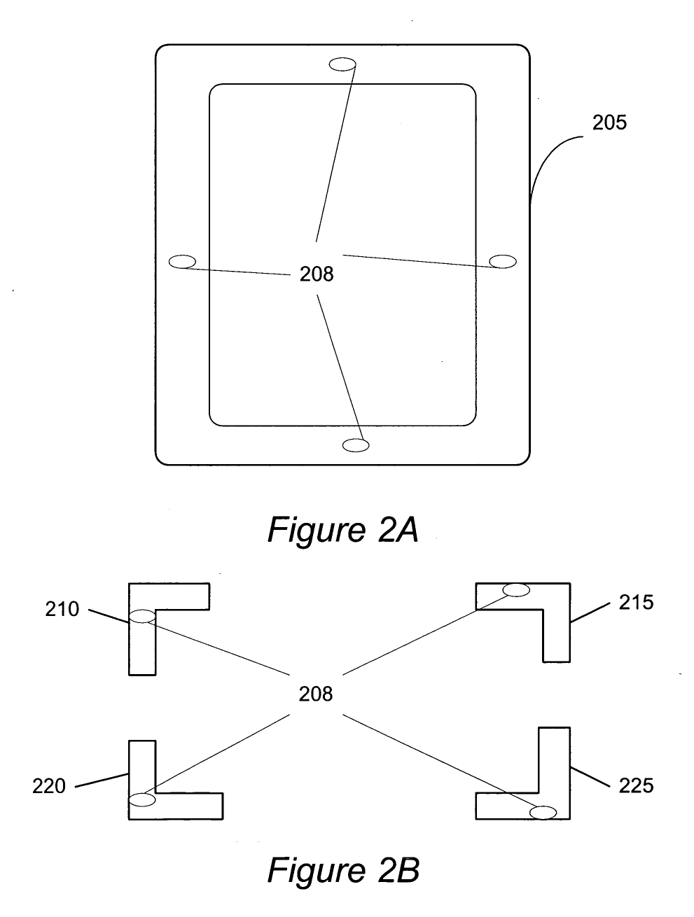

FIG. 2A and FIG. 2B illustrate shock absorbing apparatuses in accordance with one embodiment of the present invention. A ring 205 is configured to act as a shock absorber for a hard drive 115 in a portable device. The ring 205 can be made of rubber or some other pliant material that can be easily secured and provide shock insulation for the hard drive 115.

The shock absorber 205 is configured to be secured to the four outer side surfaces of the hard drive. In one embodiment, the shock absorber 205 is made in a rectangular shape of roughly the same dimensions as the hard drive 115. In an alternate embodiment, the shock absorber is elliptical or circular and shape, but can be bent to fit the hard drive by virtue of its pliable construction.

Extensions 208 extend outward in a direction perpendicular to the top/bottom surfaces of the shock absorber 208. The extensions are configured to secure the hard drive and shock absorber to the surface of the portable device. In one embodiment, the extensions 208 are rubber nipples designed to press through holes in the housing of the portable device 100. The nipples, because of their pliable construction, can be squeezed through holes in the portable device 100. After being pressed through, the nipples expand slightly, such that they cannot be easily pulled through the holes in the portable device, thus securing the hard drive 115 to the portable device 100. In one embodiment, the portable device includes a circuit board with holes previously drilled for accepting the extensions 208.

In one embodiment, the shock absorber 205 is attached to the hard drive during a manufacturing process and then provided to a manufacturer of the portable device with the shock absorber already attached. In an alternate embodiment, the shock absorber is manufactured separately and is secured to the hard drive 115 when the hard drive 115 is installed in the portable device. The shock absorber 205 can be secured to the hard drive through an adhesive, a welding process, or an alternative method.

FIG. 2B illustrates smaller shock absorbers 210, 215, 220, 225 that can also be used to protect the hard drive 105 from shock damage. The four smaller shock absorbers are each secured to the corners of the hard drive 105. Each of the smaller shock absorbers 210,215, 220, 225 include an extension 208 that can be used to secure the hard drive and the shock absorber to the portable device 100.

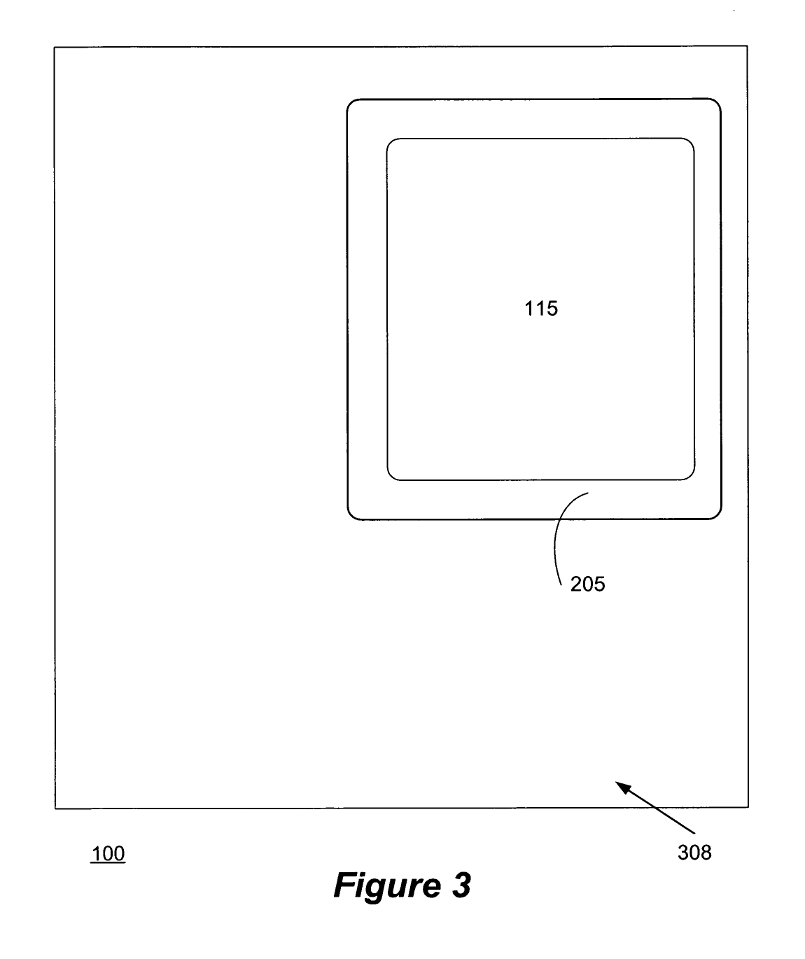

FIG. 3 illustrates an overhead view of a portable device 100 in accordance with one embodiment of the present invention. The portable device 100 includes a housing 308 which is used to store the hard drive 115 and the other components that are described in FIG. 1. While the housing 308 is illustrated as rectangular in shape, it can take any number of shapes, sizes, and configurations.

The shock absorber 205 sits between the hard drive and a surface of the housing 308. The shock absorber protects the hard drive against damage caused by vibrations or shocks from the surface of the housing 308. Additionally, the thickness of the shock absorber 205 can vary.

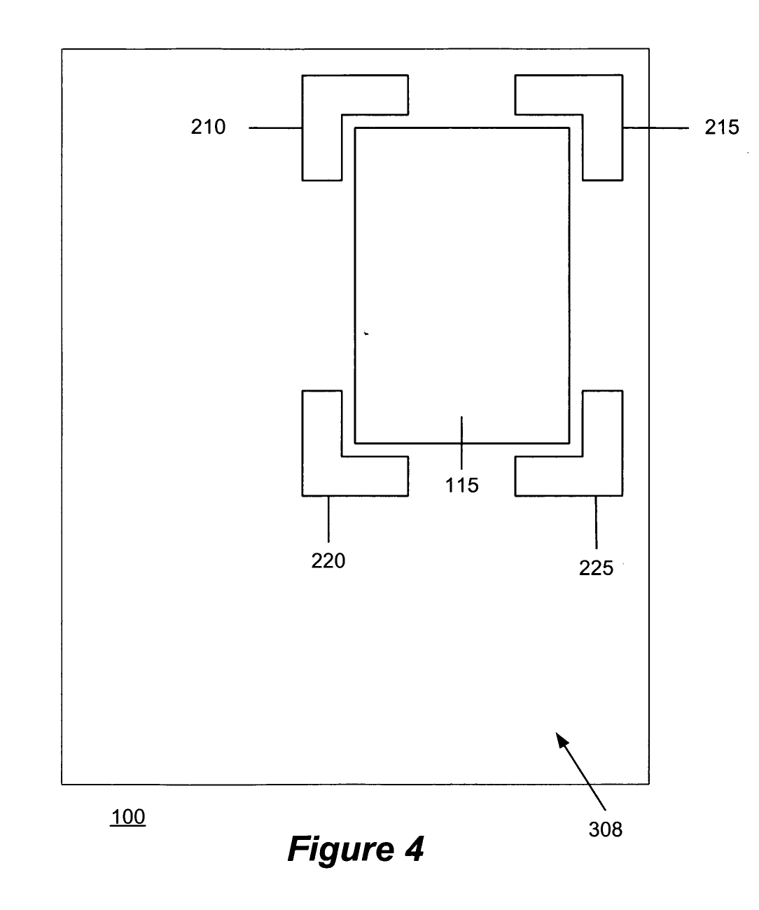

FIG. 4 is an overhead view of a portable device in accordance with an alternate embodiment of the present invention. In the present embodiment, the four smaller shock absorbers 210, 215, 220, 225 are adhered to the corner of the hard drive. One or more of the shock absorbers sits between the inner edge of the housing 308 and the hard drive 115 and insulates the hard drive 115 from shocks or impacts delivered to the portable device 100. It should be understood that two or three of the corner bumpers could be used rather than all four bumpers.

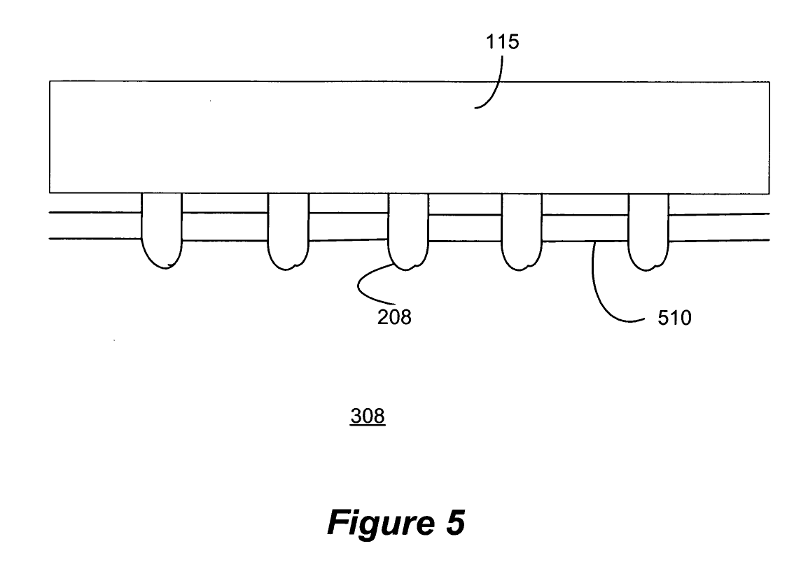

FIG. 5 is a side view illustrating one embodiment of a connection between a hard drive and the portable device in accordance with one embodiment of the present invention. In the present embodiment, the hard drive rests upon a circuit board 510 within the portable device 100. In the present embodiment, each of the extensions 208 fits through holes in the circuit board 510. In some embodiments, the extensions 208 are made of rubber or some other pliant material. In these embodiments, the extensions expand slightly after exiting the bottom of the circuit board, thus preventing the extensions from being pulled out again, and securing the hard drive to the circuit board. While FIG. 5 illustrates a circuit board, in alternate embodiments any thin surface can be used to secure the hard drive.

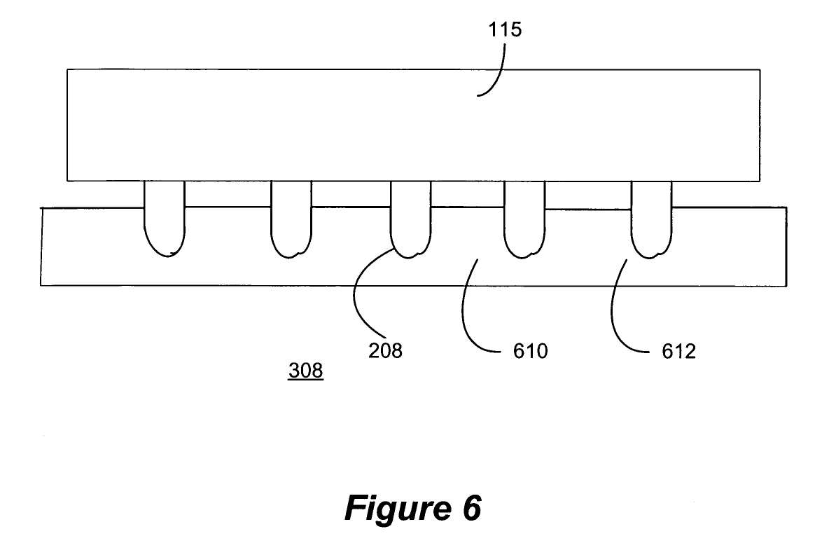

FIG. 6 is a side view illustrating one embodiment of a connection between a hard drive and the portable device in accordance with one embodiment of the present invention. In the present embodiment, the hard drive 115 is attached to a surface 610 of the housing 308 of the hard drive. In the present embodiment the surface includes one or more cavities 612 that can store the extensions 208. In one embodiment, the extensions are made of a pliant material. They are initially pressed or pressured into the cavities, and then expand to fit tightly, thus securing the shock absorber 205 and the hard drive 115 to the housing 308.

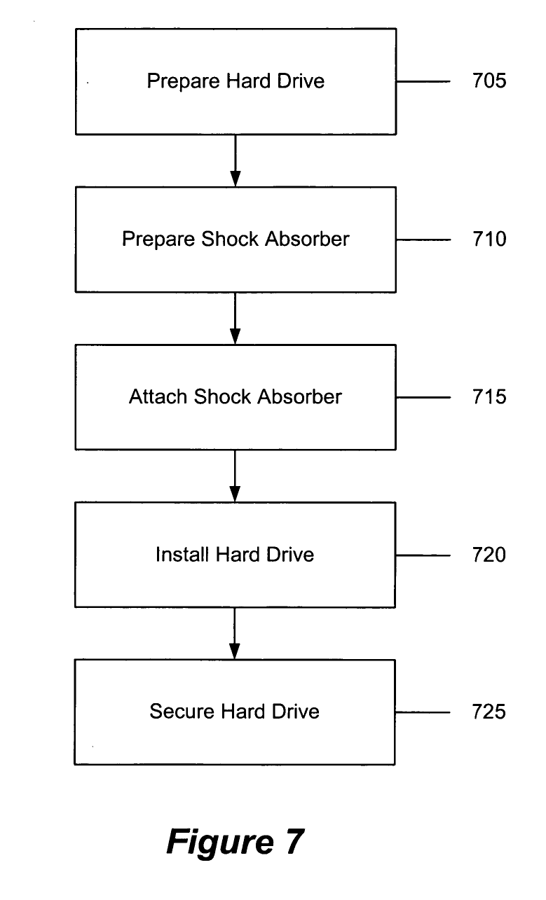

FIG. 7 illustrates a flow chart for installing a hard drive. In step 705 the hard drive 105 is prepared for use in the portable device. This step includes the manufacturing of the hard drive, the configuration and testing of the hard drive, and the addition of any specialized components that are needed to install the hard drive 105 in the portable device (e.g. connectors.).

In step 710 the shock absorber 205 or 210 is prepared for use with the hard drive 115. This step includes the manufacturing of the shock absorber 205. In one embodiment, the shock absorbers are designed specifically for a particular hard drive design. In an alternate embodiment, a generic version of the shock absorber is prepared.

In step 715 the shock absorber 205 is attached and secured to the hard drive 115. In some embodiments, this step is performed by the hard drive manufacturer and the hard drive 115 and shock absorber are shipped together to the manufacturer of the portable device 100. In alternate embodiment, the two items are manufactured separately and assembled by the manufacturer of the portable device.

In step 720 the hard drive 115 is installed in the portable device 100. This step is usually performed during a manufacturing process for the portable device. In step 725 the hard drive 115 is secured to the portable device 100. This step entails inserting the extensions 208 on the shock absorber 205 into holes in the portable device. In one embodiment, the extensions 208 are made of a pliable material such as rubber, and after being pushed through holes in the portable device, expand such that they cannot be easily pulled out of the holes, thus securing the hard drive 115.

Other features, aspects and objects of the invention can be obtained from a review of the figures and claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

What is claimed:

1. An apparatus for insulating a hard drive embedded in a portable device from external shocks, the apparatus comprising:
a shock ring comprising shock-resistant materials, the shock ring secured around an outer edge of the hard drive; and
a securing mechanism configured to secure the shock ring to an interior surface of the portable device.

2. The apparatus of claim 1, wherein the securing mechanism comprises one or more nipples extending outward from the shock ring, the nipples configured to protrude into holes in the portable device.

3. The apparatus of claim 2, wherein the holes in the portable device comprise holes in a circuit board of the portable device.

4. The apparatus of claim 1, wherein the shock ring is configured to sit between the embedded hard drive and the portable device.

5. The apparatus of claim 1, wherein an exterior surface of the shock ring is in contact with the portable device.

6. The apparatus of claim 1, wherein the apparatus is configured for storing the hard drive in a cellular phone.

7. The apparatus of claim 1, wherein the apparatus is configured for storing the hard drive in a personal data assistant.

8. The apparatus of claim 1, wherein the apparatus is configured for storing the hard drive in a laptop computer.

9. The apparatus of claim 1, wherein the apparatus is configured for storing the hard drive in a personal media player.

10. An apparatus for insulating a hard drive embedded in a portable device from external shocks, the apparatus comprising:
a plurality of shock absorbers comprising a shock resistant material, the plurality of shock absorbers secured to corners of the embedded hard drive; and
a securing mechanism configured to secure the shock absorbers to an interior surface of the portable device.

11. The apparatus of claim 10, wherein the securing mechanism comprises one or more nipples extending outward from the shock ring, the nipples configured to protrude into holes in the portable device.

12. The apparatus of claim 11, wherein the holes in the portable device comprise holes in a circuit board of the portable device.

13. The apparatus of claim 10, wherein the shock absorbers are configured to sit between the embedded hard drive and the portable device.

14. The apparatus of claim 10, wherein exterior surfaces of the shock absorbers are in contact with the portable device.

15. The apparatus of claim 10, wherein the apparatus is configured for storing the hard drive in a cellular phone.

16. The apparatus of claim 10, wherein the apparatus is configured for storing the hard drive in a personal data assistant.

17. The apparatus of claim 10, wherein the apparatus is configured for storing the hard drive in a laptop computer.

18. The apparatus of claim 10, wherein the apparatus is configured for storing the hard drive in a personal media player.

19. A portable device comprising:
a housing configured to mount functional components of the portable device;
a hard drive embedded within the portable device, wherein the hard drive can store data for the portable device; and
a shock absorbing device comprising:
at least one shock member comprising shock-resistant materials, the at least one shock member secured between the outer edge of the hard drive and an inside surface of the housing; and
a securing mechanism configured to secure the at least one shock member to an interior surface of the portable device.

20. The portable device of claim 19, wherein the securing mechanism comprises one or more nipples extending outward from the at least one shock member, the nipples configured to protrude into holes in the portable device.

21. The portable device of claim 20, wherein the holes in the portable device comprise holes in a circuit board of the portable device.

22. The portable device of claim 19, wherein the at least one shock member is configured to sit between the embedded hard drive and the portable device.

23. The portable device of claim 19, wherein the portable device comprises a cellular phone.

24. The portable device of claim 19, wherein the portable device comprises a personal data assistant.

25. The portable device of claim 19, wherein the portable device comprises a laptop computer.

26. The portable device of claim 19, wherein the portable device comprises a personal media player.

27. A method for manufacturing a portable device including a hard drive, the method comprising:
installing one or more holes in a circuit board of the portable device;
securing at least one shock absorbing member to an outer edge of the hard drive, the at least one shock absorbing member comprising one or more protrusions; and
securing the at least one shock absorbing member to the circuit board by inserting the one or more protrusions into the one or more holes.

28. The method of claim 28, wherein the portable device is a cell phone.

29. The method of claim 28, wherein the portable device is a personal data assistant.

30. The method of claim 28, wherein the portable device is a personal media player.
